(19) United States
(12) Patent Application Publication
(10) Pub. No.: US 2013/0161195 A1
(43) Pub. Date: Jun. 27, 2013

(54) ELECTROPLATING METHOD AND ARTICLE MADE BY SAME

(71) Applicants: Shi-Jie YAN, Shenzhen City (CN); He-Xian LIN, Shenzhen City (CN); Hong-Liang WANG, Shenzhen City (CN); Xiang-Hua LV, Shenzhen City (CN)

(72) Inventors: Shi-Jie YAN, Shenzhen City (CN); He-Xian LIN, Shenzhen City (CN); Hong-Liang WANG, Shenzhen City (CN); Xiang-Hua LV, Shenzhen City (CN)

(73) Assignees: FIH (HONG KONG) LIMITED, Kowloon (HK); SHENZHEN FUTAIHONG PRECISION INDUSTRY CO., LTD., ShenZhen City, (CN)

(21) Appl. No.: 13/490,764

(22) Filed: Jun. 7, 2012

(30) Foreign Application Priority Data
Dec. 27, 2011 (CN) 201110444184.7

(51) Int. Cl. C25D 5/56; B32B 19/04

(52) U.S. Cl. 205/50; 205/164

(57) ABSTRACT

An electroplating method includes at least the following steps: providing a plastic substrate; forming a preliminary layer containing metal powder and paint on the plastic substrate; laser irradiating the preliminary layer to form an intermediate layer having the metal powder exposed thereon; and electroplating an electroplated layer on the intermediate layer. This electroplating method is simple and can be applied to all kinds of plastic substrate.

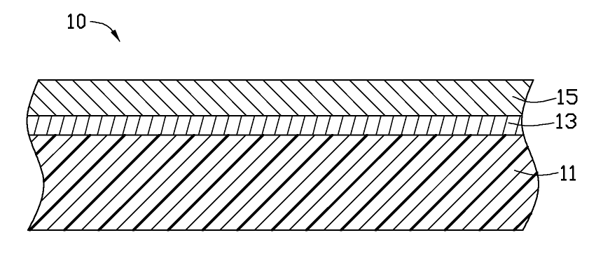

### BACKGROUND

1. Technical Field

The present disclosure relates to an electroplating method and articles made by the method.

2. Description of Related Art

An electroplating process applied to a plastic substrate usually includes the following steps: acid or alkali etching the plastic substrate to roughen the surface of the plastic substrate; electrochemically depositing a copper layer on the roughened surface of the plastic substrate; and plating metal layer on the copper layer. This electroplating method is complex.

The laser direct structure (LDS) method is applied to plastic substrate to make the surface of the plastic substrate conductive by laser activating. Then metal layers can be directly electroplated on the laser-activated surface of the plastic substrate. However, the LDS method can only be applied to the plastic substrate made of a resin containing expensive conductive materials.

Therefore, there is room for improvement within the art.

### BRIEF DESCRIPTION OF THE DRAWING

Many aspects of the housing can be better understood with reference to the following drawing. The components in the drawing are not necessarily drawn to scale, the emphasis instead being placed upon clearly illustrating the principles of the housing. Moreover, in the drawing like reference numerals designate corresponding parts throughout the drawing.

The FIGURE is a cross-sectional view of an exemplary embodiment of an article.

### DETAILED DESCRIPTION

The FIGURE shows an article 10 according to an exemplary embodiment. A method for making the article 10 may include at least the following steps:

A plastic substrate 11 is provided. The plastic substrate 11 may be made of any plastic materials, and in the exemplary embodiment, the plastic substrate 11 is made of polycarbonate, acrylonitrile-butadiene-styrene, or polyamide.

A preliminary layer (not shown) is formed on the plastic substrate 11 by spraying a mixture on the plastic substrate 11. The mixture contains metal powder and paint. The metal powder has a weight percentage of about 5% to about 15%, the remainder is paint. The metal powder may be aluminium powder, palladium powder or nickel powder. The metal powder has an average particle size of about 0.05 μm to about 0.5 μm. The paint is ultraviolet curable paint or thermosetting paint, and in the exemplary embodiment is ultraviolet curable paint. The thermosetting paint may be PU paint. The preliminary layer has a thickness of about 8 μm to about 12 μm.

An intermediate layer 13 is formed on the plastic substrate 11 by laser irradiation of the preliminary layer. The laser irradiation lasts less than 30 seconds. During the laser irradiation, part of the paint on the surface of the preliminary layer is removed, and the metal powder contained in the preliminary layer is activated and exposed on the surface of the intermediate layer 13, thus rendering the surface of the intermediate layer 13 conductive. The intermediate layer 13 has a thickness of about 1 μm to about 5 μm.

An electroplated layer 15 is formed on the intermediate layer 13 and the article 10 is formed. The electroplated layer 15 is a copper layer, a chromium layer, or a nickel layer. The electroplated layer 15 bonds securely with the intermediate layer 13.

The article 10 may have more than one electroplated layer 15 by repeatedly electroplating.

The electroplating method of the exemplary embodiment is simple, and can be applied to all kinds of plastic substrate 11.

The article 10 shown in the FIGURE includes the plastic substrate 11, the intermediate layer 13 formed on the plastic substrate 11, and the electroplated layer 15 formed on the intermediate layer 13.

The intermediate layer 13 is formed by laser irradiating the preliminary layer containing metal powder and paint. The weight percentage of the metal powder in the preliminary layer is about 5% to about 15%, the remainder is paint. The surface of the intermediate layer 13 is covered with the metal powder. The metal powder is aluminium powder, palladium powder or nickel powder. The metal powder has an average particle size in a range of about 0.05 μm to about 0.5 μm. The paint is ultraviolet curable paint or thermosetting paint, and in the exemplary embodiment is ultraviolet curable paint. The intermediate layer 13 has a thickness of about 1 μm to about 5 μm.

The electroplated layer 15 is a copper layer, a chromium layer, or a nickel layer.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. An electroplating method for making an article, comprising:
providing a plastic substrate;
forming a preliminary layer containing metal powder and paint on the plastic substrate;
laser irradiating the preliminary layer to form an intermediate layer having the metal powder exposed thereon; and
electroplating an electroplated layer on the intermediate layer.

2. The method as claimed in claim 1, wherein the metal powder is aluminium powder, palladium powder, or nickel powder.

3. The method as claimed in claim 2, wherein the metal powder has an average particle size in a range of about 0.05 μm to about 0.5 μm.

4. The method as claimed in claim 1, wherein the paint is ultraviolet curable paint or thermosetting paint.

5. The method as claimed in claim 1, wherein weight percentage of the metal powder in the preliminary layer is about 5% to about 15%, the remainder is paint.

6. The method as claimed in claim 1, wherein the intermediate layer has a thickness of about 1 μm to about 5 μm.

7. An article, comprising:
a plastic substrate;
an intermediate layer formed on the plastic substrate, the intermediate layer containing metal powder and paint, the surface of the intermediate layer being covered with the metal powder; and
an electroplated layer formed on the intermediate layer.

8. The article as claimed in claim 7, wherein the intermediate layer has a thickness of about 1 μm to about 5 μm.

9. The article as claimed in claim 7, wherein the metal powder is aluminium powder, palladium powder, or nickel powder.

10. The article as claimed in claim 9, wherein the metal powder has an average particle size in a range of about 0.05 μm to about 0.5 μm.

11. The article as claimed in claim 7, wherein the electroplated layer is a copper layer, a chromium layer, or a nickel layer.

12. The article as claimed in claim 7, wherein the paint is ultraviolet curable paint or thermosetting paint.
